(19) United States
(12) Patent Application Publication
(10) Pub. No.: US 2023/0332009 A1
(43) Pub. Date: Oct. 19, 2023

(54) PRE-PROCESSING FLUID COMPOSITION AND PRINTING METHOD

(71) Applicants: Yuusuke Fujita, Tokyo (JP); Tomohiro Nakagawa, Tokyo (JP); RICOH COMPANY, LTD., Tokyo (JP)

(72) Inventors: Yuusuke FUJITA, Tokyo (JP); Tomohiro Nakagawa, Kanagawa (JP)

(21) Appl. No.: 18/253,915

(22) PCT Filed: Nov. 17, 2021
(86) PCT No.: PCT/IB2021/060633

§ 371 Date: May 22, 2023

(30) Foreign Application Priority Data
Nov. 30, 2020 (JP) 2020-198179
Sep. 30, 2021 (JP) 2021-161502

(51) Int. Cl. C09D 11/54; B41M 5/00; C09D 11/102; C09D 11/38

(52) U.S. Cl. CPC C09D 11/54; B41M 5/0017; C09D 11/102; C09D 11/38

(57) ABSTRACT

A pre-processing fluid composition includes nonionic resin particles, a water-soluble metal salt, and water. The nonionic resin particles contain a nonionic resin having a structure derived from an aromatic ring-containing polyester polyol. A glass transition temperature of the nonionic resin particles is -30° C. or higher but 10° C. or lower.

### TECHNICAL FIELD

The present disclosure relates to a pre-processing fluid composition and a printing method.

### BACKGROUND ART

Inkjet printers have been widely available for general home use as output devices of digital signals because the inkjet printers have advantages, such as low noise, low running cost, and easy color printing. In recent years, in addition to home use, techniques for forming images on wrapping materials of food, drinks, and household items by inkjet have been being developing.

As the inkjet printers find more applications, a wider variety of print bases are used. For example, printing is often performed on a non-permeable base, such as a plastic film. In case of a wrapping material, an image is printed on a plastic film, and lamination is performed on the printed layer. When printing is performed on the non-permeable base, a fluid deposited on the base does not permeate and is not easily dried. Therefore, an ink droplet is excessively spread over to cause degradation of image quality, such as color bleeding.

As to a pre-processing fluid composition that achieves excellent adhesion and a printed area having excellent image quality without color bleeding, color unevenness, or other disadvantageous phenomena, proposed is a pre-processing fluid composition including resin particles, a surfactant, a flocculant containing a polyvalent metal salt or a cationic polymer compound, and water (see, for example, PTL 1). In order to stably disperse the resin particles in an aqueous medium, particles of a charge repulsion resin owing to ionic groups have been generally used as the resin particles.

In order to stably disperse in an aqueous medium owing to steric repulsion rather than charge repulsion to secure dispersion stability in the presence of a flocculant, such as a polyvalent metal salt, a pre-processing fluid composition including particles of a resin including a nonionic hydrophilic site has been proposed (see, for example, PTL 2).

Moreover, proposed is a set of a pre-processing fluid composition and an ink where compatibility between a layer of the pre-processing fluid composition and a layer of the ink increases on a low-absorbable print medium, such as coat paper and a cardboard, the increased adhesion leads to improvement in abrasion resistance, and the pre-processing fluid composition and the ink commonly include certain nonionic resin particles (see, for example, PTL 3).

Also, proposed is an aqueous primer that can prevent color bleeding and color unevenness and form a printed layer excellent in storage stability, adhesion, waterproofness, and lamination property when printing an image, letters, etc. on a non-absorbable print medium (e.g., a plastic film) with an inkjet printing ink composition to form a printed layer (see, for example, PTL 4).

### CITATION LIST

### Patent Literature

Japanese Unexamined Patent Application Publication No. 2019-111763
Japanese Unexamined Patent Application Publication No. 2017-222833
Japanese Unexamined Patent Application Publication No. 2018-154118
Japanese Unexamined Patent Application Publication No. 2020-075954

### SUMMARY OF INVENTION

### Technical Problem

The present disclosure has an object to provide a pre-processing fluid composition that can achieve high laminate strength and excellent dispersion stability, and can form a high quality image with a low degree of color bleeding.

### Solution to Problem

According to one aspect of the present disclosure, a pre-processing fluid composition includes nonionic resin particles, a water-soluble metal salt, and water. The nonionic resin particles comprise a nonionic resin having a structure derived from an aromatic ring-containing polyester polyol. A glass transition temperature of the nonionic resin particles is -30° C. or higher but 10° C. or lower.

### Advantageous Effects of Invention

The present disclosure can provide a pre-processing fluid composition that can achieve high laminate strength and excellent dispersion stability, and can form a high quality image with a low degree of color bleeding.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### Pre-Processing Fluid Composition

The pre-processing fluid composition of the present disclosure includes resin particles, a water-soluble metal salt, and water. The resin particles are nonionic resin particles comprising a nonionic resin having a structure derived from an aromatic ring-containing polyester polyol. A glass transition temperature of the resin particles is -30° C. or higher but 10° C. or lower.

The pre-processing fluid composition disclosed in PTL 1 has a problem that charge repulsion resin particles cannot secure sufficient dispersion stability in the presence of a flocculant, such as a polyvalent metal salt.

The pre-processing fluid compositions disclosed in PTL 2 and PTL 3 include nonionic resin particles, but have a problem that strength of the pre-processing layer is low and desirable laminate strength cannot be obtained as the nonionic resin does not have a structure derived from an aromatic ring-containing polyester polyol. The pre-processing fluid composition disclosed in PTL 2 also has a problem that the resin particles included therein have a nonionic hydrophilic group that is a long chain and have a high molecular weight to have structurally high freedom, leading to poor laminate strength.

The aqueous primer disclosed in PTL 4 includes a water-soluble polyvalent metal salt and a polyester-based polyurethane emulsion. PTL 4 does not refer to a glass transition temperature and does have a problem with poor laminate strength.

As a result of studies diligently conducted by the present inventors, the present inventors have obtained the following finding. That is, nonionic resin particles dispersed using steric repulsion can be used in the pre-processing fluid composition of the present disclosure as the nonionic resin has a nonionic hydrophilic site. Since the nonionic resin particles are resin particles mainly with steric repulsion owing to nonionic groups, rather than electrostatic repulsion owing to ionic groups, dispersion stability can be secured even in the presence of a water-soluble metal salt serving as a flocculant.

Use of the pre-processing fluid composition can increase the strength of the pre-processing layer, can suppress swelling of the pre-processing layer with a solvent included in an ink or an adhesive component, and can achieve excellent laminate strength.

Meanwhile, it has been found that laminate strength may be poor when nonionic resin particles having nonionic groups that can impart steric repulsion are used. A reason for this is not clear, but it is assumed as follows. Specifically, the resin in the particles has high molecular freedom and structurally large sites for dispersing the resin particles in an aqueous medium. When the pre-processing fluid composition is dried to form a pre-processing layer, therefore, the strength of the pre-processing layer reduces, leading to poor laminate strength because the freedom of the molecule is large and the structurally large sites are present. When an ink is applied onto the pre-processing layer, moreover, the strength of the pre-processing layer reduces as the pre-processing layer is swollen with the solvent in the ink, which may lower laminate strength. There is also a case where a solvent is used in an adhesive component at the time of lamination. The strength of the pre-processing layer also reduces by swelling of the pre-processing layer with the solvent in the adhesive component, which may lead to poor laminate strength.

The pre-processing fluid composition of the present disclosure includes nonionic resin particles, a water-soluble metal salt, and water, and may further include other components according to the necessity.

### <Nonionic Resin Particles>

Examples of the nonionic resin particles include, but are not limited to, a polyolefin resin, a polyvinyl acetate resin, a polyvinyl chloride resin, a urethane resin, a styrene butadiene resin, and copolymers of the above-listed resins. Of these, a urethane resin is preferable because the urethane resin has excellent adhesion to a base and can form a pre-processing layer having excellent laminate strength. These may be used alone or in combination.

The nonionic resin particles are particles of a nonionic resin having a structure derived from an aromatic ring-containing polyester polyol.

Since the nonionic resin particles have nonionic hydrophilic sites, the nonionic resin particles are dispersed utilizing steric repulsion, which are resin particles mainly with steric repulsion owing to nonionic groups, rather than electrostatic repulsion owing to ionic groups. Therefore, dispersion stability can be secured even in the presence of a water-soluble metal salt serving as a flocculant. Ionic groups and nonionic groups may be used in combination, but the resin particles are resin particles mainly with steric repulsion owing to nonionic groups, rather than electrostatic repulsion owing to ionic groups. For this reason, an absolute value of zeta potential of the resin particles of the present disclosure is preferably 10 mV or less and more preferably 5 mV or less.

When the particles of the resin having nonionic groups that can impart steric repulsion are used, laminate strength may be poor. A reason for this is not clear, but it is assumed as follows. Specifically, the resin in the particles has high molecular freedom and structurally large sites for dispersing the resin particles in an aqueous dispersion. When the pre-processing fluid composition is dried to form a pre-processing layer, therefore, the strength of the pre-processing layer reduces, leading to poor laminate strength because the freedom of the molecule is large and the structurally large sites are present.

The glass transition temperature of the nonionic resin particles is -30° C. or higher but 10° C. or lower. When the glass transition temperature is -30° C. or higher but 10° C. or lower, a pre-processing layer having excellent adhesion to a base and excellent anti-swelling against a solvent can be formed, and can achieve excellent laminate strength.

The nonionic urethane resin particles can be obtained through a reaction between at least polymer polyol, nonionic group-containing polyvalent alcohol, polyvalent isocyanate, and polyvalent amine.

As a production method of the nonionic resin particles, a method generally used in the art can be used. For example, polymer polyol, nonionic group-containing polyvalent alcohol, and polyvalent isocyanate (D) are allowed to react in the absence of a solvent or in the presence of an organic solvent, to produce an isocyanate-terminated urethane prepolymer, water is added to the resultant for dispersing and the isocyanate remaining at the terminals and polyvalent amine are allowed to react through a chain-elongation reaction, and finally the organic solvent in the system is optionally removed to obtain nonionic resin particles.

A ratio of isocyanate to hydroxyl group during the reaction is preferably 1.1 or greater but 1.7 or less and more preferably 1.2 or greater but 1.5 or less. Since the isocyanate ratio is 1.1 or greater but 1.7 or less, resin particles having excellent solvent resistance can be obtained.

The polymer polyol includes an aromatic ring-containing polyester polyol. Since the aromatic structure is included in the polymer polyol site, the strength of the pre-processing layer can be increased in the presence of functional groups having high freedom and being structurally large in order to disperse the resin particles in water.

The molecular weight of the polymer polyol is preferably 1,000 or greater but 3,000 or less, and more preferably 1,000 or greater but 2,000 or less. Since the molecular weight is 1,000 or greater but 3,000 or less, resin particles having excellent solvent resistance can be obtained, and when an ink is applied onto the pre-processing layer, swelling of the resin with the solvent in the ink and reduction in strength of the pre-processing layer can be suppressed, and excellent laminate strength can be obtained.

Whether the nonionic resin particles have the structure derived from the aromatic ring-containing polyester polyol can be confirmed in the following manner.

First, the nonionic resin particles are dried to obtain a resin film. The obtained resin film is subjected to FT-IR spectroscopy (Nicolet6700, obtained from Thermo Fisher Scientific) to detect a peak derived from a carboxyl group, and pyrolysis-gas chromatography/mass spectrometry (JMS-Q1000GC2, obtained from JEOL Ltd.) at a pyrolysis temperature of 400° C. to detect peaks derived from a polyvalent carboxylic acid compound having an aromatic ring, and a polyvalent alcohol compound having an aromatic ring.

For example, the urethane resin particles may include short chain polyvalent alcohols, such as C2-C15 polyvalent alcohols (e.g., ethylene glycol, propylene glycol, 1,4-butanediol, 1,5-pentanediol, neopentyl glycol, 1,6-hexanediol, 1,8-octanediol, 1,4-cyclohexanedimethanol, diethylene glycol, glycerin, and trimethylol propane.

Examples of the polyvalent isocyanate include, but are not limited to: aromatic polyisocyanate compounds, such as 1,3-phenylene diisocyanate, 1,4-phenylene diisocyanate, 2,4-tolylene diisocyanate (TDI), 2,6-tolylene diisocyanate, 4,4′-diphenylmethane diisocyanate (MDI), 2,4-diphenylmethane diisocyanate, 4,4′-diisocyanatobiphenyl, 3,3′-dimethyl-4,4′-diisocyanatobiphenyl, 3,3′-dimethyl-4,4′-diisocyanatodiphenylmethane, 1,5-naphthylene diisocyanate, 4,4′4″-triphenylmethane triisocyanate, m-isocyanatophenylsulfonyl isocyanate, and p-isocyanatophenylsulfonyl isocyanate; aliphatic polyisocyanate compounds, such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine triisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; and alicyclic polycyanate compounds, such as isophorone diisocyanate (IPDI), 4,4′-dicyclohexylmethane diisocyanate (hydrogenated MDI), cyclohexylene diisocyanate, methylcyclohexylene diisocyanate (hydrogenated TDI), bis(2-isocyanatoethyl)-4-cyclohexane-1,2-dicarboxylate, 2,5-norbornane diisocyanate, and 2,6- norbornane diisocyanate. The above-listed examples may be used alone or in combination. Of these, aliphatic polyisocyanate and alicyclic polyisocyanate are preferable, alicyclic polyisocyanate is more preferable, and isophorone diisocyanate and 4,4′-dicyclohexylmethane diisocyanate are particularly preferable.

Examples of the polyvalent amine include, but are not limited to: diamines, such as ethylene diamine, 1,2-propanediamine, 1,6-hexamethylenediamine, piperazine, 2,5-dimethylpiperazine, isophoronediamine, 4,4′-dicyclohexylmethane diamine, and 1,4-cyclohexanediamine; polyamines, such as diethylene triamine, dipropylene triamine, and triethylene tetramine; hydrazines, such as hydrazine, N,N′-dimethylhydrazine, and 1,6-hexamethylene bishydrazine; and succinic acid dihydrazide, adipic acid dihydrazide, glutaric acid dihydrazide, sebacic acid dihydrazide, and isophthalic acid dihydrazide. Of these, trifunctional amine is particularly preferably used.

For example, the nonionic aliphatic group structure imparting steric repulsion is preferably a structure derived from polyethylene glycol or polypropylene glycol, and more preferably a structure derived from polyethylene glycol.

Whether the nonionic resin particles have a structure derived from polyethylene glycol, polypropylene glycol, etc., can be confirmed, for example, by subjecting a resin film obtained by drying the nonionic resin particles to pyrolysis-gas chromatography/mass spectrometry (JMS-Q1000GC2, obtained from JEOL Ltd.) at a pyrolysis temperature of 400° C. to detect peaks derived from polyethylene glycol, polypropylene glycol, etc.

The proportion of the nonionic resin particles relative to the pre-processing fluid composition is preferably 5% by mass or greater but 30% by mass or less, more preferably 7% by mass or greater but 25% by mass or less, and particularly preferably 10% by mass or greater but 20% by mass or less. When the amount of the nonionic resin particles is 5% by mass or greater but 30% by mass or less, excellent wettability and adhesion can be obtained, and a pre-processing layer to be formed has excellent transparency.

### <Water-Soluble Metal Salt>

The water-soluble metal salt is not particularly limited as long as the water-soluble metal salt can be used as a flocculant, and may be appropriately selected depending on the intended purpose. Considering formation of an excellent image in terms of color bleeding, blurring, and coloring ability, the water-soluble metal salt is preferably a polyvalent metal salt. More preferably, the water-soluble metal salt is a metal salt containing a divalent or trivalent metal ion.

Examples of the water-soluble metal salt include, but are not limited to, titanium salt, chromium salt, copper salt, cobalt salt, strontium salt, barium salt, iron salt, aluminium salt, calcium salt, potassium salt, sodium salt, nickel salt, and magnesium salt. Specific examples thereof include, but are not limited to, calcium carbonate, calcium nitrate, calcium chloride, calcium acetate, calcium sulfate, magnesium chloride, magnesium acetate, magnesium sulfate, nickel chloride, barium sulfate, zinc sulfide, zinc carbonate, aluminium silicate, calcium silicate, magnesium silicate, aluminium hydroxide, aluminium sulfate, aluminium phosphate, aluminium lactate, polyaluminium chloride, iron(III) sulfate, aluminium potassium sulfate, potassium iron alum, and ferric ammonium alum.

The metal salt has a function to make dispersion of the coloring material in the ink unstable to aggregate the coloring material. The metal salt promptly aggregates the coloring material in the ink after depositing droplets of the ink, and an image having excellent coloring can be formed while preventing color bleeding and blurring.

### <Organic Solvent>

The organic solvent is not particularly limited and may be appropriately selected depending on the intended purpose. For example, a water-soluble organic solvent can be used. Examples of the water-soluble organic solvent include, but are not limited to, polyvalent alcohols, ethers (e.g., polyvalent alcohol alkyl ethers and polyvalent alcohol aryl ethers), nitrogen-containing heterocyclic compounds, amides, amines, and sulfur-containing compounds.

Specific examples of the water-soluble organic solvent include, but are not limited to: polyvalent alcohols, such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methylpentane-1,3,5-triol; polyvalent alcohol alkyl ethers, such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyvalent alcohol aryl ethers, such as ethylene glycol monophenyl ether, and ethylene glycol monobenzyl ether; nitrogen-containing heterocyclic compounds, such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides, such as formamide, N-methylformamide, N,N-dimethylformamide, 3-methoxy-N,N-dimethylpropionamide, and 3-butoxy-N,N-dimethylpropionamide; amines, such as monoethanol amine, diethanol amine, and triethylamine; sulfur-containing compounds, such as dimethyl sulfoxide, sulfolane, and thiodiethanol; propylene carbonate; ethylene carbonate; C8 or higher polyol compounds; and glycol ether compounds.

Examples of the C8 or higher polyol compounds include, but are not limited to, 2-ethyl-1,3-hexanediol and 2,2,4-trimethyl-1,3-pentanediol.

Examples of the glycol ether compounds include, but are not limited to: polyvalent alcohol alkyl ethers, such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyvalent alcohol aryl ether, such as ethylene glycol monophenyl ether and ethylene glycol monobenzyl ether.

The proportion of the organic solvent relative to the pre-processing fluid composition is not particularly limited and may be appropriately selected depending on the intended purpose. The proportion thereof is preferably 5% by mass or greater but 60% by mass or less, more preferably 10% by mass or greater but 40% by mass or less, and particularly preferably 10% by mass or greater but 25% by mass or less.

The organic solvent may be used alone or may be used as a mixture of two or more organic solvents according to the intended purpose.

### <Surfactant>

Examples of the surfactant include, but are not limited to, a silicone-based surfactant, a fluorine-based surfactant, an amphoteric surfactant, a nonionic surfactant, and an anionic surfactant.

The silicone-based surfactant is not particularly limited and may be appropriately selected depending on the intended purpose. The silicone-based surfactant is preferably a silicone-based surfactant that is not decomposed in a high pH environment. Examples thereof include, but are not limited to, side chain-modified polydimethylsiloxane, both end-modified polydimethylsiloxane, one end-modified polydimethylsiloxane, and side-chain-both-end-modified polydimethylsiloxane. Of these, the silicone-based surfactant is preferably a silicone-based surfactant including a polyoxyethylene group or a polyoxyethylene polyoxypropylene group as a modifying group because such a surfactant exhibits excellent characteristics as an aqueous surfactant.

As the silicone-based surfactant, for example, a polyether-modified silicone-based surfactant may be used. Examples thereof include, but are not limited to, a compound in which a polyalkylene oxide structure is introduced into the side chain of the Si site of dimethylsiloxane.

For example, the fluorine-based surfactant is particularly preferably a perfluoroalkyl sulfonic acid compound, a perfluoroalkyl carboxylic acid compound, a perfluoroalkyl phosphoric acid ester compound, a perfluoroalkyl ethylene oxide adduct, and a polyoxyalkylene ether polymer compound having a perfluoroalkyl ether group in the side chain thereof because of low foamability. Examples of the perfluoroalkyl sulfonic acid compound include, but are not limited to, perfluoroalkyl sulfonic acid and perfluoroalkyl sulfonic acid salts. Examples of the perfluoroalkyl carboxylic acid compound include, but are not limited to, perfluoroalkyl carboxylic acid and perfluoroalkyl carboxylic acid salts. Examples of the polyoxyalkylene ether polymer compound having a perfluoroalkyl ether group in the side chain thereof include, but are not limited to, sulfuric acid ester salts of a polyoxyalkylene ether polymer having a perfluoroalkyl ether group in a side chain thereof, and salts of a polyoxyalkylene ether polymer having a perfluoroalkyl ether group in the side chain thereof. Examples of counter ions of the salts of the above-listed fluorine-based surfactants include, but are not limited to, Li, Na, K, NH₄, NH₃CH₂CH₂OH, NH₂(CH₂CH₂OH)₂, and NH(CH₂CH₂OH)₃. Examples of the amphoteric surfactant include, but are not limited to, lauryl aminopropionic acid salts, lauryl dimethyl betaine, stearyl dimethyl betaine, and lauryl dihydroxyethyl betaine.

Examples of the nonionic surfactant include, but are not limited to, polyoxyethylene alkyl phenyl ether, polyoxyethylene alkyl ester, polyoxyethylene alkyl amine, polyoxyethylene alkyl amide, polyoxyethylene propylene block polymer, sorbitan fatty acid ester, polyoxyethylene sorbitan fatty acid ester, and acetylene alcohol ethylene oxide adducts. Examples of the anionic surfactant include, but are not limited to, polyoxyethylene alkyl ether acetic acid salt, dodecylbenzene sulfonic acid salt, lauric acid salt, and polyoxyethylene alkyl ether sulfate salt. The above-listed examples may be used alone or in combination.

The silicone-based surfactant is not particularly limited and may be appropriately selected depending on the intended purpose. Examples thereof include, but are not limited to, side chain-modified polydimethylsiloxane, both end-modified polydimethylsiloxane, one end-modified polydimethylsiloxane, and side-chain-both-end-modified polydimethylsiloxane. The silicone-based surfactant is preferably a polyether-modified silicone-based surfactant having a polyoxyethylene group or a polyoxyethylene polyoxypropylene group as a modifying group because such a surfactant exhibits excellent characteristics as an aqueous surfactant.

The above-mentioned surfactant may be appropriately synthesized for use, or may be selected from commercial products. For example, the commercial products thereof can be obtained from BYK-Chemie GmbH, Shin-Etsu Chemical Co., Ltd., Dow Corning Toray Co., Ltd., Nihon Emulsion Co., Ltd., and KYOEISHA CHEMICAL CO., LTD.

The polyether-modified silicone-based surfactant is not particularly limited and may be appropriately selected depending on the intended purpose. Examples thereof include, but are not limited to, a compound represented by Chemical Formula S-1, in which a polyalkylene oxide structure is introduced into a side chain of the Si site of dimethyl polysiloxane. [Chem. 1]

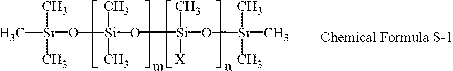

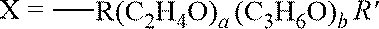

In the Chemical structure S-1, “m”, “n”, “a”, and “b” each, respectively represent integers, R represents an alkylene group, and R′ represents an alkyl group.

In the General Formula S-1, “m” and “n” are each preferably an integer of 1 or greater but 10 or less, and “a” and “b” are each preferably an integer of 1 or greater but 30 or less. As the polyether-modified silicone-based surfactant, commercial products may be used. Examples thereof include, but are not limited to: KF-618, KF-642, and KF-643 (obtained from Shin-Etsu Chemical Co., Ltd.); EMALEX-SS-5602 and SS-1906EX (obtained from Nihon Emulsion Co., Ltd.); FZ-2105, FZ-2118, FZ-2154, FZ-2161, FZ-2162, FZ-2163, and FZ-2164 (obtained from Dow Corning Toray Co., Ltd.); BYK-33 and BYK-387 (obtained from BYK-Chemie GmbH); and TSF4440, TSF4452, and TSF4453 (obtained from Momentive Performance Materials Inc.).

The fluorine-based surfactant is preferably a C2-C16 fluorine-substituted compound and more preferably a C4-C16 fluorine-substituted compound.

Examples of the fluorine-based surfactant include, but are not limited to, a perfluoroalkyl phosphoric acid ester compound, a perfluoroalkyl ethylene oxide adduct, a polyoxyalkylene ether polymer compound having a perfluoroalkyl ether group in the side chain thereof. Of these, a polyoxyalkylene ether polymer compound having a perfluoroalkyl ether group in the side chain thereof is preferable because of low foamability, and fluorine-based surfactants represented by General Formulae (F-1) and (F-2) are particularly preferable.

[Chem. 2]

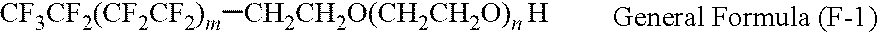

In order to impart water solubility to the compound represented by General Formula (F-1), m is preferably an integer of from 0 through 10 and n is preferably an integer of from 0 through 40.

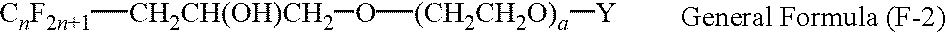

In the compound represented by General Formula (F-2), Y is H, CnF₂ₙ₊₁ where n is an integer of from 1 through 6, or CH₂CH(OH)CH₂-CnF₂ₙ₊₁ where n is an integer of from 4 through 6, or CpH₂ₚ₊₁ where p is an integer of from 1 through 19; and a is an integer of from 4 through 14.

As the fluorine-based surfactant, commercial products may be used.

Examples of the commercial products thereof include, but are not limited to: SURFLON S-111, S-112, S-113, S-121, S-131, S-132, S-141, and S-145 (all obtained from ASAHI GLASS CO., LTD.); FLUORAD FC-93, FC-95, FC-98, FC-129, FC-135, FC-170C, FC-430, and FC-431 (all obtained from SUMITOMO 3M); MEGAFACE F-470, F-1405, and F-474 (all obtained from DIC CORPORATION); ZONYL TBS, FSP, FSA, FSN-100, FSN, FSO-100, FSO, FS-300, and UR (all obtained from DuPont); FT-110, FT-250, FT-251, FT-400S, FT-150, and FT-400SW (all obtained from NEOS COMPANY LIMITED); POLYFOX PF-136A,PF-156A, PF-151N, PF-154, and PF-159 (all obtained from OMNOBA SOLUTIONS INC.); and UNIDYNE DSN-403N (obtained from DAIKIN INDUSTRIES). Of these,FS-300 (obtained from DuPont), FT-110, FT-250, FT-251, FT-400S, FT-150, and FT-400SW (obtained from NEOS COMPANY LIMITED), PolyFox PF-151N (obtained from OMNOVA SOLUTIONS INC.), and UNIDYNE DSN-403N (obtained from DAIKIN INDUSTRIES) are particularly preferable considering excellent print quality, particularly coloring ability, and significant improvement in permeation, wettability, and uniform dying properties.

The proportion of the surfactant relative to the pre-processing fluid composition is not particularly limited and may be appropriately selected depending on the intended purpose. The proportion thereof is preferably 0.001% by mass or greater but 5% by mass or less and more preferably 0.05% by mass or greater but 5% by mass or less.

### <Defoaming Agent>

The defoaming agent is not particularly limited. Examples thereof include, but are not limited to, a silicone-based defoaming agent, a polyether-based defoaming agent, and a fatty acid ester-based defoaming agent. The above-listed defoaming agents may be used alone or in combination.

### <Preservatives and Fungicides>

The preservatives and fungicides are not particularly limited. Examples thereof include, but are not limited to, 1,2-benzisothiazolin-3-one.

### <Corrosion Inhibitor>

The corrosion inhibitor is not particularly limited. Examples thereof include, but are not limited to, acid sulfite and sodium thiosulfate.

### <pH Regulator>

The pH regulator is not particularly limited as long as the pH regulator can adjust the pH to 7 or higher. Examples thereof include, but are not limited to, amines, such as diethanolamine and triethanolamine.

A method for applying the pre-processing fluid composition onto the base is not particularly limited, and any of methods known in the art can be used. Examples thereof include, but are not limited to, inkjet printing, blade coating, gravure coating, gravure offset coating, bar coating, roll coating, knife coating, air knife coating, comma coating, U-comma coating, AKKU coating, smoothing coating, microgravure coating, reverse roll coating, 4-roll coating, 5-roll coating, dip coating, curtain coating, slide coating, and die coating.

An amount of the pre-processing fluid composition applied is preferably 1 g/m² or greater but 6 g/m² or less. When the amount thereof is 1 g/m² or greater but 6 g/m² or less, excellent adhesion, laminate strength, and haze can be achieved, and a high quality image can be obtained while preventing blurring.

### <Ink>

An ink used in combination with the pre-processing fluid composition of the present disclosure will be described.

The ink preferably includes water, a coloring material, an organic solvent, and resin particles.

### <Organic Solvent>

There is no specific limitation on the type of the organic solvent used in the present disclosure. For example, water-soluble organic solvents are suitable. Specific examples thereof include, but are not limited to, polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate. Since the water-soluble organic solvent serves as a humectant and also imparts a good drying property, it is preferable to use an organic solvent having a boiling point of 250° C. or lower.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol. Specific examples of the glycolether compounds include, but are not limited to, polyol alkylethers such as ethyleneglycol monoethylether, ethyleneglycol monobutylether, diethylene glycol monomethylether, diethyleneglycol monoethylether, diethyleneglycol monobutylether, tetraethyleneglycol monomethylether, propyleneglycol monoethylether; and polyol arylethers such as ethyleneglycol monophenylether and ethyleneglycol monobenzylether.

The proportion of the organic solvent in ink has no particular limit and can be suitably selected to suit a particular application.

In terms of the drying property and discharging reliability of the ink, the proportion is preferably from 10 to 60 percent by mass and more preferably from 20 to 60 percent by mass.

### <Water>

The proportion of water in the ink has no particular limit. In terms of the drying property and discharging reliability of the ink, the proportion is preferably from 10 to 90 percent by mass and more preferably from 20 to 60 percent by mass.

### <Coloring Material>

The coloring material has no particular limit. For example, pigments and dyes are suitable. The pigment includes inorganic pigments and organic pigments. These can be used alone or in combination. In addition, it is possible to use a mixed crystal.

As the pigments, for example, black pigments, yellow pigments, magenta pigments, cyan pigments, white pigments, green pigments, orange pigments, gloss pigments of gold, silver, etc., and metallic pigments can be used.

As the inorganic pigments, in addition to titanium oxide, iron oxide, calcium oxide, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black can be used. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rohdamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63; C.I. Pigment Green 1, 4, 7, 8, 10, 17, 18, and 36.

The type of dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

Considering improvement in image density, and excellent fixability and discharging stability, the proportion of the coloring material in the ink is preferably 0.1% by mass or greater but 20% by mass or less and more preferably 1% by mass or greater but 15% by mass or less.

To obtain the ink, the pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment to be added to ink is not necessarily coated with resin. Pigments partially or wholly uncovered with resin may be dispersed in the ink unless the pigments have an adverse impact.

To use a dispersant, for example, a known dispersant of a small molecular weight type or a high molecular weight type represented by a surfactant is used to disperse the pigments in ink. As the dispersant, it is possible to use, for example, anionic surfactants, cationic surfactants, nonionic surfactants, amphoteric surfactants, etc. depending on the pigments.

Also, a nonionic surfactant (RT-100, manufactured by TAKEMOTO OIL & FAT CO., LTD.) and a formalin condensate of naphthalene sodium sulfonate are suitable as dispersants.

These dispersants can be used alone or in combination.

### <Pigment Dispersion>

The ink can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by mixing and dispersing water, pigment, pigment dispersant, and other optional components and adjusting the particle size. It is good to use a dispersing device for dispersion.

The particle diameter of the pigment in the pigment dispersion has no particular limit. For example, the maximum frequency in the maximum number conversion is preferably from 20 to 500 nm and more preferably from 20 to 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the content is preferably from 0.1 to 50 percent by mass and more preferably from 0.1 to 30 percent by mass.

During the production, coarse particles are optionally filtered off with a filter, a centrifuge, etc. preferably followed by degassing.

### <Resin>

The type of the resin contained in the ink has no particular limit. Specific examples thereof include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Particles of such resins may be also used. It is possible to mix a resin emulsion in which the resin particles are dispersed in water serving as a dispersion medium with materials such as a coloring agent and an organic solvent to obtain ink. The resin particle can be synthesized or is available on the market. It is possible to synthesize the resin particle or obtain from market. These can be used alone or in combination of the resin particles.

The volume average particle diameter of the resin particle is not particularly limited and can be suitably selected to suit to a particular application. The volume average particle diameter is preferably from 10 to 1,000 nm, more preferably from 10 to 200 nm, and furthermore preferably from 10 to 100 nm to obtain good fixability and image density. The volume average particle diameter can be measured by using a particle size analyzer (Nanotrac Wave-UT151, manufactured by MicrotracBEL Corp.).

The proportion of the resin is not particularly limited and can be suitably selected to suit to a particular application. In terms of fixability and storage stability of ink, it is preferably from 1 to 30 percent by mass and more preferably from 5 to 20 percent by mass to the total content of the ink.

The glass transition temperature of the resin particles is preferably 30° C. or higher but 100° C. or lower and more preferably 40° C. or higher but 80° C. or lower.

The resin particles having the above-mentioned glass transition temperature contribute to formation of an excellent image having improved blocking resistance and abrasion resistance.

Ink may further optionally contain a surfactant, a defoaming agent, a preservative and fungicide, a corrosion inhibitor, a pH regulator, etc.

### <Surfactant>

Examples of the surfactant are silicone-based surfactants, fluorosurfactants, amphoteric surfactants, nonionic surfactants, anionic surfactants, etc.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl silooxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, steallyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates. These can be used alone or in combination.

The silicone-based surfactant has no particular limit. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group is particularly preferable because such a surfactant demonstrates good characteristics as an aqueous surfactant.

Any suitably synthesized surfactant and any product thereof available on the market is suitable. Products available on the market are obtained from Byc Chemie Japan Co., Ltd., Shin-Etsu Silicone Co., Ltd., Dow Corning Toray Co., Ltd., etc., EMULSION Co., Ltd., Kyoeisha Chemical Co., Ltd., etc.

The polyether-modified silicon-containing surfactant has no particular limit. For example, a compound in which the polyalkylene oxide structure represented by the following Chemical structure S-1 is introduced into the side chain of the Si site of dimethyl polysiloxane. [Chem. 3]

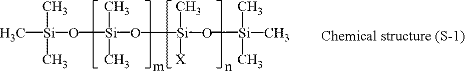

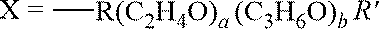

In the Chemical structure S-1, “m”, “n”, “a”, and “b” each, respectively represent integers, R represents an alkylene group, and R′ represents an alkyl group.

In the General Formula S-1, “m” and “n” are each preferably an integer of 1 or greater but 10 or less, and “a” and “b” are each preferably an integer of 1 or greater but 30 or less.

Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Japan KK.), and TSF4440, TSF4452, and TSF4453 (all manufactured by Momentive Performance Materials Inc.).

A fluorosurfactant in which the number of carbon atoms replaced with fluorine atoms is from 2 to 16 is preferable and, 4 to 16, more preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not foam easily and the fluorosurfactant represented by the following Chemical formula F-1 or Chemical formula F-2 is more preferable. [Chem. 4]

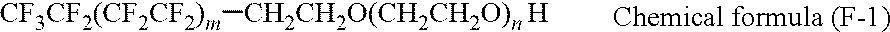

In the Chemical formula F-1, “m” is preferably 0 or an integer of from 1 to 10 and “n” is preferably 0 or an integer of from 1 to 40.

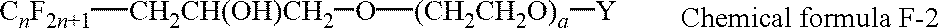

In the Chemical formula F-2, Y represents H, CₙF₂ₙ₊₁, where “n” is an integer of from 1 to 6, H₂CH(OH)CH₂-CₙF₂ₙ₊₁, where n represents an integer of from 4 to 6, or CₚH₂ₚ₊₁, where p represents an integer of from 1 to 19. “a” represents an integer of from 4 to 14. Products available on the market may be used as the fluorosurfactant. Specific examples of the products available on the market include, but are not limited to, SURFLON S-111, SURFLON S-112, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3 M); MEGAFACE F-470, F-1405, and F-474 (all manufactured by DIC CORPORATION); ZONYL™ TBS, FSP, FSA, FSN-100, FSN, FSO-100, FSO, FS-300, UR (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, PF-159 (manufactured by OMNOVA SOLUTIONS INC.), and UNIDYNE DSN-403N (manufactured by DAIKIN INDUSTRIES). Of these, FS-300 (manufactured by The Chemours Company), FT-110, FT-250, FT-251, FT-400S, FT-150, and FT-400SW (all manufactured by The Chemours Company), PolyFox PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dying property to paper.

The proportion of the surfactant in ink is not particularly limited. It is preferably from 0.001 to 5 percent by mass and more preferably from 0.05 to 5 percent by mass ink in terms of excellent wettability and discharging stability and improvement on image quality.

### <Defoaming Agent>

The defoaming agent has no particular limit. For example, silicon-based defoaming agents, polyether-based defoaming agents, and aliphatic acid ester-based defoaming agents are suitable. These can be used alone or in combination. Of these, silicone-based defoaming agents are preferable to easily break foams.

### <Preservatives and Fungicides>

The preservatives and fungicides are not particularly limited. A specific example is 1,2-benzisothiazolin-3-on.

### <Corrosion Inhibitor>

The corrosion inhibitor has not particular limit. Examples thereof are acid sulfite and sodium thiosulfate.

### <pH Regulator>

The pH regulator has no particular limit. It is preferable to adjust the pH to 7 or higher. Specific examples thereof include, but are not limited to, amines such as diethanol amine and triethanol amine.

### <Ink Set>

The fluid composition for surface processing and the ink may be provided as an ink set. As an ink in the ink set, a non-white ink and/or a white ink may be used.

### <Print Medium>

A print medium for use in the present disclosure is not particularly limited. As the print medium, plain paper, gloss paper, specialty paper, or cloth may be used. The pre-processing fluid composition of the present disclosure is particularly suitably used on a non-permeable base. In the present disclosure, the non-permeable base is a base having a surface of low water permeation, absorption, and/or adsorption, and also includes a material including a number of pores therein that are not open outside. More quantitatively speaking, the non-permeable base is a base having a water absorption of 10 mL/m² or less when the water absorption is measured according to the Bristow method from the initial contact to 30 msec^{½}. Examples of the non-permeable base, but are not limited to, any of plastic films, such as a vinyl chloride resin film, a polyethylene terephthalate (PET) film, a polypropylene film, a polyethylene film, a polycarbonate film, and a nylon film, and biodegradable plastic (bioplastic).

### <Printing Method and Printing Device>

The printing method of the present disclosure preferably includes a surface-modification step, a pre-processing fluid composition applying step, and an ink applying step. The surface-modification step is performing surface-modification on a print medium. The pre-processing fluid composition applying step is applying the pre-processing fluid composition to the print medium. The ink applying step is applying an ink to the print medium to which the pre-processing fluid composition has been applied.

### <Surface-Modification Step>

In the surface-modification step, it may be possible to use any of processing methods that can reduce unevenness and improve adhesion when the fluid composition is applied. Examples thereof include, but are not limited to, a corona treatment, an atmospheric plasma treatment, a frame treatment, and a UV irradiation treatment.

The above-listed treatment methods can be performed by any of devices known in the art.

Of the above-listed treatment methods, the surface modification of the printing surface is preferably performed by a corona treatment step including performing a corona discharge treatment or a streamer treatment step (plasma treatment) including performing a streamer discharge treatment. The corona treatment step or the streamer treatment step is preferably used because the corona treatment step or the streamer treatment step has excellent output stability of corona discharge or a surface treatment is uniformly performed on the printing surface compared with the atmospheric plasma treatment, the frame treatment, and the UV irradiation treatment.

### <Pre-Processing Fluid Composition Applying Step>

A coating method of the pre-processing fluid composition in the pre-processing fluid composition applying step is not particularly limited, and any of known methods in the art may be used. Examples thereof include, but are not limited to, inkjet coating, blade coating, gravure coating, gravure offset coating, bar coating, roll coating, knife coating, air knife coating, comma coating, U-comma coating, AKKU coating, smoothing coating, microgravure coating, reverse roll coating, 4-roll coating, 5-roll coating, dip coating, curtain coating, slide coating, and die coating. Since an image of the highest quality is obtained when the amount of the pre-processing fluid composition applied is from 1 g/m² through 6 g/m², an appropriate coating method is preferably selected depending on a material or thickness of the base for use.

### <Ink Applying Step>

As the ink applying step, an inkjet system is suitably used.

The ink applying step preferably includes a printing step and a circulating step. The printing step is discharging an ink using an inkjet head to print. The inkjet head includes nozzles configured to discharge an ink, individual liquid chambers in communication with the nozzles, an inflow channel configured to supply the ink to the individual liquid chamber, and an outflow channel configured to discharge the ink from the individual liquid chamber. The circulating step is circulating the ink from the outflow channel to the inflow channel. The ink including the resin component may be likely to cause discharge disruption due to fluctuations of the conditions over time. The circulating step contributes to formation of a high quality image with less image defects, such as discharge disruption, with high productivity.

The printing method preferably further includes a heating treatment step after the ink applying step.

When a non-white ink and a white ink are used in combination as the inks, there are two embodiments. One embodiment is where application of the non-white ink is followed by application of the white ink. The other embodiment is where application of the white ink is followed by application of the non-white ink. The heating treatment step is preferably performed after the non-white ink applying step and after the white ink applying step.

### <Printing Device and Printing Method>

The ink of the present disclosure can be suitably applied to various printing devices employing an inkjet printing method such as printers, facsimile machines, photocopiers, multifunction peripherals (serving as a printer, a facsimile machine, and a photocopier), and 3D model manufacturing devices (3D printers, additive manufacturing device). In the present disclosure, the printing device and the printing method represent a device capable of discharging ink, various processing fluids, etc. to a print medium and a method printing an image on the print medium using the device. The print medium means an article to which the ink or the various processing fluids can be attached at least temporarily. The printing device may further optionally include a device relating to feeding, transferring, and ejecting the print medium and other devices referred to as a pre-processing device, a post-processing device, etc. in addition to the head portion to discharge the ink. The printing device and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing.

In addition, the printing device and the printing method are not limited to those producing merely meaningful visible images such as texts and figures with the ink. For example, the printing device and the printing method can produce patterns like geometric design and 3D images.

In addition, the printing device includes both a serial type device in which the liquid discharging head is caused to move and a line type device in which the liquid discharging head is not moved, unless otherwise specified.

Furthermore, in addition to the desktop type, this printing device includes a wide type capable of printing images on a large print medium such as A0, a continuous printer capable of using continuous paper wound up in a roll form as print media.

This printing device includes may include not only a portion discharging ink but also a device referred to as a pre-processing device, a post-processing device, etc.

As an example of the pre-processing device and the post-processing device, as in the case of the ink such as black (K), cyan (C), magenta (M), and yellow (Y), a liquid container containing a pre-processing fluid composition or a post-processing fluid and a liquid discharging head are added to discharge the pre-processing fluid composition or the post-processing fluid in an inkjet printing method.

As another example of the pre-processing device and the post-processing device, it is suitable to dispose a pre-processing device and a post-processing device employing a blade coating method, a roll coating method, or a spray coating method other than the inkjet printing method.

How to use the ink is not limited to the inkjet printing method. Specific examples of such methods other than the inkjet printing method include, but are not limited to, blade coating methods, gravure coating methods, bar coating methods, roll coating methods, knife coating methods, dip coating methods, die coating methods, and spray coating methods.

### EXAMPLES

The present disclosure will be described below in more detail by way of Examples and Comparative Examples. The present disclosure should not be construed as being limited to these Examples. In Examples and Comparative Examples, “part(s)” denotes “part(s) by mass” and “%” denotes “% by mass” excluding “%” in evaluation criteria.

### Preparation of Pre-Processing Fluid Composition

### -Polyester Polyol 1-

A 0.5 L separable flask was charged with 114 g of 1,6-hexanediol, 100 g of neopentyl glycol, and 267 g of dimethyl isophthalate with introducing nitrogen therein, and the resultant mixture was melted at 130° C. When the mixture was melted, 0.14 g of titanium tetraisopropoxide was added. The resultant was heated to 230° C. for from 3 through 4 hours with stirring, and then the mixture was allowed to further react for 2 through 3 hours at 230° C. Thereafter, 0.07 g of titanium tetraisopropoxide was added, and the resultant was retained for 2 hours, followed by stopping the introduction of nitrogen. The resultant was allowed to react for 2 hours under a reduced pressure of 1 kPa, to obtain Polyester Polyol 1.

### -Resin Particles 1-

A 0.5 L separable flask equipped with a stirring blade, a thermometer, and a reflux tube was charged with 100 g of Polyester Polyol 1, 13 g of polyoxyethylene side chain-containing diol, and 90 g of acetone with introducing nitrogen therein, and the resultant was heated to 40° C. to melt the starting materials. Subsequently, 35 g of isophorone diisocyanate and one drop of tin(II) 2-ethylhexanoate were added, and the resultant mixture was heated to 80° C. and allowed to react for 4 hours. Thereafter, the reaction mixture was cooled to 40° C. To the cooled reaction mixture, 270 g of water was added to form particles, and 2 g of diethylene triamine was further added and the resultant was allowed to react for 4 hours. Finally, the acetone was removed to obtain Resin Particles 1 (urethane resin, glass transition temperature: -5° C., nonionic resin particles).

Resin Particles 1 obtained were dried to form a resin film. The obtained resin film was subjected to FT-IR spectroscopy to confirm a peak derived from a carboxyl group, and was subjected to pyrolysis-gas chromatography/mass spectrometry at a pyrolysis temperature of 400° C. to confirm a peak derived from a polyvalent carboxylic compound having an aromatic ring (dimethyl isophthalate), to confirm that Resin Particles 1 had a structure derived from aromatic ring-containing polyester polyol. Moreover, the resin film obtained by drying Resin Particles 1 was subjected to pyrolysis-gas chromatography/mass spectrometry at a pyrolysis temperature of 400° C. to confirm a peak derived from a polyethylene glycol structure, to confirm that Resin Particles 1 had a structure derived from polyethylene glycol.

### -Polyester Polyol 2-

A 5 L separable flask was charged with 118 g of 1,6-hexanediol, 104 g of neopentyl glycol, 110 g of dimethyl isophthalate, and 149 g of dimethyl adipate with introducing nitrogen therein, and the resultant mixture was melted at 130° C. When the mixture was melted, 0.14 g of titanium tetraisopropoxide was added. The resultant was heated to 230° C. for from 3 through 4 hours with stirring, and then the mixture was allowed to further react for 2 through 3 hours at 230° C. Thereafter, 0.07 g of titanium tetraisopropoxide was added, and the resultant was retained for 2 hours, followed by stopping the introduction of nitrogen. The resultant was allowed to react for 2 hours under a reduced pressure of 1 kPa, to obtain Polyester Polyol 2.

### -Resin Particles 2-

A 0.5 L separable flask equipped with a stirring blade, a thermometer, and a reflux tube was charged with 100 g of Polyester Polyol 2, 13 g of polyoxyethylene side chain-containing diol, and 90 g of acetone with introducing nitrogen therein, and the resultant was heated to 40° C. to melt the starting materials. Subsequently, 33 g of isophorone diisocyanate, and one drop of tin(II) 2-ethylhexanoate were added, and the resultant mixture was heated to 80° C. and allowed to react for 4 hours. Thereafter, the reaction mixture was cooled to 40° C. To the cooled reaction mixture, 265 g of water was added to form particles, and 2 g of diethylene triamine was added and the resultant was allowed to react for 4 hours. Finally, the acetone was removed to obtain Resin particles 2 (urethane resin, glass transition temperature: -16° C., nonionic resin particles).

Resin Particles 2 obtained were dried to form a resin film. The obtained resin film was subjected to FT-IR spectroscopy to confirm a peak derived from a carboxyl group, and was subjected to pyrolysis-gas chromatography/mass spectrometry at a pyrolysis temperature of 400° C. to confirm a peak derived from a polyvalent carboxylic compound having an aromatic ring (dimethyl isophthalate), to confirm that Resin Particles 2 had a structure derived from aromatic ring-containing polyester polyol. Moreover, the resin film obtained by drying Resin Particles 2 was subjected to pyrolysis-gas chromatography/mass spectrometry at a pyrolysis temperature of 400° C. to confirm a peak derived from a polyethylene glycol structure, to confirm that Resin Particles 2 had a structure derived from polyethylene glycol.

### -Polyester Polyol 3-

A 0.5 L separable flask was charged with 116 g of 1,6-hexanediol, 102 g of neopentyl glycol, 190 g of dimethyl isophthalate, and 73 g of dimethyl adipate with introducing nitrogen, and the resultant mixture was melted at 130° C. When the mixture was melted, 0.14 g of titanium tetraisopropoxide was added. The resultant was heated to 230° C. for from 3 through 4 hours with stirring, and then the mixture was allowed to further react for 2 through 3 hours at 230° C. Thereafter, 0.07 g of titanium tetraisopropoxide was added, and the resultant was retained for 2 hours, followed by stopping the introduction of nitrogen. The resultant was allowed to react for 2 hours under a reduced pressure of 1 kPa, to obtain Polyester Polyol 3.

### -Resin Particles 3-

A 0.5 L separable flask equipped with a stirring blade, a thermometer, and a reflux tube was charged with 100 g of Polyester Polyol 3, 13 g of polyoxyethylene side chain-containing diol, and 90 g of acetone with introducing nitrogen therein, and the resultant was heated to 40° C. to melt the starting materials. Subsequently, 35 g of isophorone diisocyanate, and one drop of tin(II) 2-ethylhexanoate were added, and the resultant mixture was heated to 80° C. and allowed to react for 4 hours. Thereafter, the reaction mixture was cooled to 40° C. To the cooled reaction mixture, 270 g of water was added to form particles, and 2 g of diethylene triamine was added and the resultant was allowed to react for 4 hours. Finally, the acetone was removed to obtain Resin Particles 3 (urethane resin, glass transition temperature: -10° C., nonionic particles).

Resin Particles 3 obtained were dried to form a resin film. The obtained resin film was subjected to FT-IR spectroscopy to confirm a peak derived from a carboxyl group, and was subjected to pyrolysis-gas chromatography/mass spectrometry at a pyrolysis temperature of 400° C. to confirm a peak derived from a polyvalent carboxylic compound having an aromatic ring (dimethyl isophthalate), to confirm that Resin Particles 3 had a structure derived from aromatic ring-containing polyester polyol. Moreover, the resin film obtained by drying Resin Particles 3 was subjected to pyrolysis-gas chromatography/mass spectrometry at a pyrolysis temperature of 400° C. to confirm a peak derived from a polyethylene glycol structure, to confirm that Resin Particles 3 had a structure derived from polyethylene glycol.

### -Polyester Polyol 4-

A 0.5 L separable flask was charged with 120 g of 1,6-hexanediol, 106 g of neopentyl glycol, and 254 g of dimethyl adipate with introducing nitrogen therein, and the resultant mixture was melted at 130° C. When the mixture was melted, 0.14 g of titanium tetraisopropoxide was added. The resultant was heated to 230° C. for from 3 through 4 hours with stirring, and then the mixture was allowed to further react for 2 through 3 hours at 230° C. Thereafter, 0.07 g of titanium tetraisopropoxide was added, and the resultant was retained for 2 hours, followed by stopping the introduction of nitrogen. The resultant was allowed to react for 2 hours under a reduced pressure of 1 kPa, to obtain Polyester Polyol 4.

### -Resin Particles 4-

A 0.5 L separable flask equipped with a stirring blade, a thermometer, and a reflux tube was charged with 100 g of Polyester Polyol 4, 13 g of polyoxyethylene side chain-containing diol, and 90 g of acetone with introducing nitrogen therein, and the resultant was heated to 40° C. to melt the starting materials. Subsequently, 35 g of isophorone diisocyanate, and one drop of tin(II) 2-ethylhexanoate were added, and the resultant mixture was heated to 80° C. and allowed to react for 4 hours. Thereafter, the reaction mixture was cooled to 40° C. To the cooled reaction mixture, 270 g of water was added to form particles, and 2 g of diethylene triamine was added and the resultant was allowed to react for 4 hours. Finally, the acetone was removed to obtain Resin Particles 4 (urethane resin, glass transition temperature: -31° C., nonionic resin particles).

Resin Particles 4 obtained was dried to form a resin film. The obtained resin film was subjected to pyrolysis-gas chromatography/mass spectrometry at a pyrolysis temperature of 400° C. to confirm a peak derived from a polyethylene glycol structure, to confirm that Resin Particles 4 had a structure derived from polyethylene glycol.

### -Resin Particles 5-

A 0.5 L separable flask equipped with a stirring blade, a thermometer, and a reflux tube was charged with 100 g of Polyester Polyol 2, 5.5 g of 2,2-bishydroxymethyl propionic acid, 4 g of triethylamine, and 80 g of acetone with introducing nitrogen therein, and the resultant was heated to 40° C. to melt the starting materials. Subsequently, 35 g of isophorone diisocyanate and one drop of tin(II) 2-ethylhexanoate were added, and the resultant mixture was heated to 80° C. and allowed to react for 4 hours. Thereafter, the reaction mixture was cooled to 40° C. To the cooled reaction mixture, 270 g of water was added to form particles, and 2.3 g of diethylene triamine were added and the resultant was allowed to react for 4 hours. Finally, the acetone was removed to obtain Resin Particles 5 (urethane resin, glass transition temperature: 7° C., anionic resin particles).

Resin Particles 5 obtained were dried to form a resin film. The obtained resin film was subjected to FT-IR spectroscopy to confirm a peak derived from a carboxyl group, and was subjected to pyrolysis-gas chromatography/mass spectrometry at a pyrolysis temperature of 400° C. to confirm a peak derived from a polyvalent carboxylic compound having an aromatic ring (dimethyl isophthalate), to confirm that Resin Particles 5 had a structure derived from aromatic ring-containing polyester polyol.

### -Resin Particles 6-

A mixture including 44 parts by mass of methyl methacrylate, 52 parts by mass of 2-ethylhexyl acrylate, 4 parts by mass of methoxy polyethylene glycol monomethacrylate, 1.5 parts by mass of HITENOL HS-10 (obtained from DKS Co., Ltd.) serving as a reactive emulsifier, and 43 parts by mass of ion-exchanged water was emulsified using a homomixer, to obtain a homogeneous milky white emulsion.

Next, a 1 L flask equipped with a stirrer, a thermometer, a nitrogen inlet tube, and a reflux tube was charged with 89 parts by mass of water pH of which had been adjusted to 3 in advance with ion-exchanged water and sulfuric acid, and the water was heated to 70° C. with introducing nitrogen therein.

Subsequently, 13 parts by mass of a 10% by mass HITENOL HS-10 (obtained from DKS Co., Ltd.) aqueous solution serving as a reactive emulsifier, and 2.6 parts by mass of a 5% by mass ammonium persulfate aqueous solution were added. To this, the previously prepared emulsion was continuously added by dripping over 2.5 hours.

Moreover, 1.8 parts by mass of a 5% by mass ammonium persulfate aqueous solution was added every hour during the period from the beginning of the dripping to 3 hours from the beginning of the dripping.

After completing the dripping, the resultant mixture was matured at 70° C. for 2 hours, followed by cooling. The pH of the resultant was adjusted to the range of 7 to 8 with a sodium hydroxide aqueous solution, to obtain a dispersion liquid of Resin Particles 6 (glass transition temperature: -18° C., anionic resin particles).

Since methoxy polyethylene glycol monomethacrylate was used for the preparation of Resin Particles 6, Resin Particles 6 were particles of an acrylic resin having a structure derived from polyethylene glycol.

### -Polyester Polyol 5-

A 0.5 L separable flask was charged with 177 g of 1,2-propanediol, 160 g of dimethyl terephthalate, and 144 g of dimethyl adipate with introducing nitrogen therein, and the resultant mixture was melted at 130° C. When the mixture was melted, 0.14 g of titanium tetraisopropoxide was added. The resultant was heated to 230° C. for from 3 through 4 hours with stirring, and then the mixture was allowed to further react for 2 through 3 hours at 230° C. Thereafter, 0.07 g of titanium tetraisopropoxide was added, and the resultant was retained for 2 hours, followed by stopping the introduction of nitrogen. The resultant was allowed to react for 2 hours under a reduced pressure of 1 kPa, to obtain Polyester Polyol 5.

### -Resin Particles 7-

A 0.5 L separable flask equipped with a stirring blade, a thermometer, and a reflux tube was charged with 100 g of Polyester Polyol 5, 13 g of polyoxyethylene side chain-containing diol, and 90 g of acetone with introducing nitrogen therein, and the resultant was heated to 40° C. to melt the starting materials. Subsequently, 33 g of isophorone diisocyanate and one drop of tin(II) 2-ethylhexanoate were added, and the resultant mixture was heated to 80° C. and allowed to react for 4 hours. Thereafter, the reaction mixture was cooled to 40° C. To the cooled reaction mixture, 270 g of water was added to form particles, and 2.3 g of diethylene triamine was added and the resultant was allowed to react for 4 hours. Finally, the acetone was removed to obtain Resin Particles 7 (urethane resin, glass transition temperature: 18° C., nonionic resin particles).

Resin Particles 7 obtained were dried to form a resin film. The obtained resin film was subjected to FT-IR spectroscopy to confirm a peak derived from a carboxyl group, and was subjected to pyrolysis-gas chromatography/mass spectrometry at a pyrolysis temperature of 400° C. to confirm a peak derived from a polyvalent carboxylic compound having an aromatic ring (dimethyl terephthalate), to confirm that Resin Particles 7 had a structure derived from aromatic ring-containing polyester polyol. Moreover, the resin film obtained by drying Resin Particles 7 was subjected to pyrolysis-gas chromatography/mass spectrometry at a pyrolysis temperature of 400° C. to confirm a peak derived from a polyethylene glycol structure, to confirm that Resin Particles 7 had a structure derived from polyethylene glycol.

### -Polyester Polyol 6-

A 0.5 L separable flask was charged with 112 g of 1,6-propanediol, 150 g of neopentyl glycol, 20 g of dimethyl isophthalate, and 231 g of dimethyl adipate with introducing nitrogen therein, and the resultant mixture was melted at 130° C. When the mixture was melted, 0.14 g of titanium tetraisopropoxide was added. The resultant was heated to 230° C. for from 3 through 4 hours with stirring, and then the mixture was allowed to further react for 2 through 3 hours at 230° C. Thereafter, 0.07 g of titanium tetraisopropoxide was added, and the resultant was retained for 2 hours, followed by stopping the introduction of nitrogen. The resultant was allowed to react for 2 hours under a reduced pressure of 1 kPa, to obtain Polyester Polyol 6.

### -Resin Particles 8-

A 0.5 L separable flask equipped with a stirring blade, a thermometer, and a reflux tube was charged with 100 g of Polyester Polyol 6, 13 g of polyoxyethylene side chain-containing diol, and 90 g of acetone with introducing nitrogen therein, and the resultant was heated to 40° C. to melt the starting materials. Subsequently, 33 g of isophorone diisocyanate and one drop of tin(II) 2-ethylhexanoate were added, and the resultant mixture was heated to 80° C. and allowed to react for 4 hours. Thereafter, the reaction mixture was cooled to 40° C. To the cooled reaction mixture, 265 g of water was added to form particles, and 2 g of diethylene triamine was added and the resultant was allowed to react for 4 hours. Finally, the acetone was removed to obtain Resin Particles 8 (urethane resin, glass transition temperature: -35° C., nonionic resin particles).

Resin Particles 8 obtained were dried to form a resin film. The obtained resin film was subjected to FT-IR spectroscopy to confirm a peak derived from a carboxyl group, and was subjected to pyrolysis-gas chromatography/mass spectrometry at a pyrolysis temperature of 400° C. to confirm a peak derived from a polyvalent carboxylic compound having an aromatic ring (dimethyl isophthalate), to confirm that Resin Particles 8 had a structure derived from aromatic ring-containing polyester polyol. Moreover, the resin film obtained by drying Resin Particles 8 was subjected to pyrolysis-gas chromatography/mass spectrometry at a pyrolysis temperature of 400° C. to confirm a peak derived from a polyethylene glycol structure, to confirm that Resin Particles 8 had a structure derived from polyethylene glycol.

The materials were blended and stirred according to the composition presented in Tables 1 to 3, and the resultant was filtered through a filter of 5 micrometers (Minisart, obtained from Satorius AG) to prepare a pre-processing fluid composition.

The resin particle dispersion liquid was blended to achieve the solid content presented in Tables 1 to 3. At the time the solid content was adjusted, the amount of the ion-exchanged water was added depending on the amount of the resin particles so that a total amount was to be 100 parts by mass.

TABLE 1

| | | Pre-processing fluid 1 | Pre-processing fluid 2 | Pre-processing fluid 3 | Pre-processing fluid 4 | Pre-processing fluid 5 | Pre-processing fluid 6 | Pre-processing fluid 7 |
|---|---|---|---|---|---|---|---|---|
| Flocculant | Calcium acetate monohydrate | 2.5 | 2.5 | 2.5 | 2.5 | 2.5 | 2.5 | 2.5 |
| | Magnesium sulfate | | | | | | | |
| | Aluminium sulfate hexadecahvdrate | | | | | | | |
| | Sodium chloride | | | | | | | |
| Resin particles (solid content) | Resin particles 1 (gt temp.: -5° C.) | 15 | 20 | 10 | 7 | 5 | | |
| | Resin particles 2 (gt temp.: -16° C.) | | | | | | 15 | |
| | Resin particles 3 (gt temp.: -10° C.) | | | | | | | 15 |
| | Resin particles 4 (gt temp.: -31° C.) | | | | | | | |
| | Resin particles 5 (gt temp.: 7° C.) | | | | | | | |
| | Resin particles 6 (gt temp.: -18° C.) | | | | | | | |
| | Resin particles 7 (gt temp.: 18° C.) | | | | | | | |
| | Resin particles 8 (gt temp.: -35° C.) | | | | | | | |
| Surfactant | FS-300 | 1 | 1 | 1 | 1 | 1 | 1 | 1 |
| Fungicide | PROXEL LV | 0.1 | 0.1 | 0.1 | 0.1 | 0.1 | 0.1 | 0.1 |
| Organic solvent | 2,3-butanediol | 10 | 10 | 10 | 10 | 10 | 10 | 10 |
| | 1,2-propane diol | | | | | | | |
| | 3-methoxy-3-methyl-1-butanol | 10 | 10 | 10 | 10 | 10 | 10 | 10 |
| | 4-methyl-1,2-pentanediol | | | | | | | |
| Water | Ion-exchanged water | Bal. | Bal. | Bal. | Bal. | Bal. | Bal. | Bal. |
| Total | | 100 | 100 | 100 | 100 | 100 | 100 | 100 |

In Table 1, “gt temp.” stands for “glass transition temperature” and “Bal.” stands for “balance”.

TABLE 2

| | | Pre-processing fluid 8 | Pre-processing fluid 9 | Pre-processing fluid 10 | Pre-processing fluid 11 | Pre-processing fluid 12 | Pre-processing fluid 13 | Pre-processing fluid 14 |
|---|---|---|---|---|---|---|---|---|
| Flocculant | Calcium acetate monohydrate | | | | 2.5 | 2.5 | 2.5 | |
| | Magnesium sulfate | | 2.8 | | | | | 2.8 |
| | Aluminium sulfate hexadecahydrate | | | 2.0 | | | | |
| | Sodium chloride | 2.9 | | | | | | |
| Resin particles (solid content) | Resin particles 1 (gt temp.: -5° C.) | 15 | 15 | 15 | | | 15 | |
| | Resin particles 2 (gt temp.: -16° C.) | | | | | | | |
| | Resin particles 3 (gt temp.: -10° C.) | | | | | | | |
| | Resin particles 4 (gt temp.: -31° C.) | | | | | | | |
| | Resin particles 5 (gt temp.: 7° C.) | | | | | | | |
| | Resin particles 6 (gt temp.: -18° C.) | | | | | 15 | | |
| | Resin particles 7 (gt temp.: 18° C.) | | | | 15 | | | |
| | Resin particles 8 (gt temp.: -35° C.) | | | | | | | |
| Surfactant | FS-300 | 1 | 1 | 1 | 1 | 1 | 1 | 1 |
| Fungicide | PROXEL LV | 0.1 | 0.1 | 0.1 | 0.1 | 0.1 | 0.1 | 0.1 |
| Organic solvent | 2,3-butanediol | 10 | 10 | 10 | 10 | 10 | | |
| | 1,2-propane diol | | | | | | 15 | 10 |
| | 3-methoxy-3-methyl-1-butanol | 10 | 10 | 10 | 10 | 10 | 10 | 10 |
| | 4-methyl-1,2-pentanediol | | | | | | | |
| Water | Ion-exchanged water | Bal. | Bal. | Bal. | Bal. | Bal. | Bal. | Bal. |
| Total | | 100 | 100 | 100 | 100 | 100 | 100 | 100 |

In Table 2, “gt temp.” stands for “glass transition temperature” and “Bal.” stands for “balance”.

TABLE 3

| | | Pre-processing fluid 15 | Pre-processing fluid 16 | Pre-processing fluid 17 | Pre-processing fluid 18 | Pre-processing fluid 19 | Pre-processing fluid 20 | Pre-processing fluid 21 |
|---|---|---|---|---|---|---|---|---|
| Flocculant | Calcium acetate monohydrate | 2.5 | 2.5 | 2.5 | | 2.5 | 2.5 | 2.5 |
| | Magnesium sulfate | | | | | | | 2.8 |
| | Aluminium sulfate hexadecahydrate | | | | | | | |
| | Sodium chloride | | | | | | | |
| Resin particles (solid content) | Resin particles 1 (gt temp.: -5° C.) | 15 | | | | | 4 | |
| | Resin particles 2 (gt temp.: -16° C.) | | | | | | | |
| | Resin particles 3 (gt temp.: -10° C.) | | | | | | | |
| | Resin particles 4 (gt temp.: -31° C.) | | 15 | | | | | |
| | Resin particles 5 (gt temp.: 7° C.) | | | 15 | 15 | | | |
| | Resin particles 6 (gt temp.: -18° C.) | | | | | 10 | | |
| | Resin particles 7 (gt temp.: 18° C.) | | | | | | | |
| | Resin particles 8 (gt temp.: -35° C.) | | | | | | | 15 |
| Surfactant | FS-300 | 1 | 1 | 1 | 1 | 1 | 1 | 1 |
| Fungicide | PROXEL LV | 0.1 | 0.1 | 0.1 | 0.1 | 0.1 | 0.1 | 0.1 |
| Organic solvent | 2,3-butanediol | | 10 | 10 | 10 | 10 | | |
| | 1,2-propane diol | 15 | | | | | 15 | 10 |
| | 3-methoxy-3-methyl-1-butanol | | 10 | 10 | 10 | 10 | 10 | 10 |
| | 4-methyl-1,2-pentanediol | 5 | | | | | | |
| Water | Ion-exchanged water | Bal. | Bal. | Bal. | Bal. | Bal. | Bal. | Bal. |
| Total | | 100 | 100 | 100 | 100 | 100 | 100 | 100 |

In Table 3, “gt temp.” stands for “glass transition temperature” and “Bal.” stands for “balance”.

Details of some components in Table 1 to Table 3 are as follows.
FS-300: fluorine-based surfactant, obtained from Sigma-Aldrich Co.
PROXEL LV: Fungicide, obtained from Lonza Co.

### Preparation of Pigment Dispersion Liquid-

### Preparation Example of Cyan Pigment Dispersion Liquid

The materials were blended according to the following formulation, and the resultant mixture was circulated and dispersed by means of a disk-type bead mill (KDL-model, obtained from SHINMARU ENTERPRISES CORPORATION, media: zirconia balls having a diameter of 0.3 mm) for 7 hours, to obtain a pigment dispersion liquid (pigment solid content: 15% by mass).
Pigment Blue 15:3 (product name: LIONOL BLUE FG-7351, obtained from TOYO INK CO., LTD.): 15 parts by mass
Anionic surfactant (Pionin A-51-B, obtained from TAKEMOTO OIL & FAT Co., Ltd.): 2 parts by mass
Ion-exchanged water: 83 parts by mass

### Preparation Example of Magenta Pigment Dispersion Liquid

A magenta pigment dispersion liquid (pigment solid content: 15% by mass) was prepared in the same manner as the preparation example of the cyan pigment dispersion liquid, except that Pigment Blue 15:3 (product name: LIONOL BLUE FG-7351, obtained from TOYO INK CO., LTD.) was replaced with Pigment Red 122 (product name: Toner Magenta EO02, obtained from Clariant Japan K.K.).

### Preparation Example of Yellow Pigment Dispersion Liquid

A yellow pigment dispersion liquid (pigment solid content: 15% by mass) was prepared in the same manner as the preparation example of the cyan pigment dispersion liquid, except that Pigment Blue 15:3 (product name: LIONOL BLUE FG-7351, obtained from TOYO INK CO., LTD.) was replaced with Pigment Yellow 74 (product name: Fast Yellow 531, obtained from Dainichiseika Color & Chemicals Mfg. Co., Ltd.).

### Preparation Example of Black Pigment Dispersion Liquid

A black pigment dispersion liquid (pigment solid content: 15% by mass) was prepared in the same manner as the preparation example of the cyan pigment dispersion liquid, except that Pigment Blue 15:3 (product name: LIONOL BLUE FG-7351, obtained from TOYO INK CO., LTD.) was replaced with a carbon black pigment (product name: Monarch 800, obtained from Cabot Corporation).

### Preparation Example of White Pigment Dispersion Liquid

Twenty-five parts by mass of titanium oxide (product name: STR-100W, obtained from SAKAI CHEMICAL INDUSTRY CO., LTD.), 5 parts by mass of a pigment dispersant (product name: TEGO Dispers 651, obtained from Evonik Japan Co., Ltd.), and 70 parts by mass of water were blended, and the resultant mixture was dispersed by means of a bead mill (product name: Research Lab, obtained from SHINMARU ENTERPRISES CORPORATION) packed with zirconia beads having a diameter of 0.3 mm at the filling rate of 60%, at 8 m/s for 5 minutes, to obtain a white pigment dispersion liquid (pigment solid content: 25% by mass).

The materials were blended and stirred according to the formulation presented in Table 4, and the resultant mixture was filtered through a polypropylene filter of 0.2 micrometers, to thereby prepare each ink.

TABLE 4

| | Ink 1 | Ink 2 | Ink 3 | Ink 4 | Ink 5 |
|---|---|---|---|---|---|
| Black pigment dispersion (solid content) | 4 | | | | |
| Magenta pigment dispersion (solid content) | | 4 | | | |
| Yellow pigment dispersion (solid content) | | | 4 | | |
| Cyan pigment dispersion (solid content) | | | | 4 | |
| White pigment dispersion (solid content) | | | | | 7 |
| SUPERFLEX 210 (solid content) | 7 | 7 | 7 | 7 | 7 |
| FS-300 | 2 | 2 | 2 | 2 | 2 |
| 1,2-propanediol | 30 | 30 | 30 | 30 | 30 |
| Diethylene glycol monobutyl ether | 5 | 5 | 5 | 5 | 5 |
| PROXEL LV | 0.1 | 0.1 | 0.1 | 0.1 | 0.1 |
| Ion-exchanged water | Balance | Balance | Balance | Balance | Balance |
| Total | 100 | 100 | 100 | 100 | 100 |

Details of some components in Table 4 are as follows.
SUPERFLEX 210: urethane resin, obtained from DKS Co. Ltd.
FS-300: fluorine-based surfactant, obtained from Sigma-Aldrich Co.
PROXEL LV: Fungicide, obtained from Lonza Co.

### (Examples 1 to 22 and Comparative Examples 1 to 7)

In Examples 1 to 22 and Comparative Examples 1 to 7, each of the pre-processing fluid compositions presented in Table 5 to Table 8 was applied with a bar coater onto a PET film (E5100, obtained from TOYOBO CO., LTD.), followed by drying. An inkjet printer (IPSIO GXe5500, obtained from Ricoh Company Limited) was charged with the produced ink, and the ink was applied onto the PET film to which the pre-processing fluid composition had been applied to print a solid image, followed by drying. A dry laminate adhesive (main agent TM-320/curing agent CAT-13B, obtained from Toyo-Morton, Ltd.) was applied onto the printed image with a bar coater, and the resultant was bonded to CPP (P1128, obtained from TOYOBO CO., LTD.), followed by aging at 40° C. for 48 hours, to obtain a laminate. Next, in each of Examples 1 to 22 and Comparative Examples 1 to 7, “laminate strength of printed area,” “color bleeding,” “storage stability (dispersion stability),” and “surface roughness” were evaluated in the following manners. The results are presented in Tables 5 to 8.

### Laminate Strength of Printed Area

The laminate was cut into a 15 mm-width piece, followed by measuring peeling strength using Autograph AGS-5kNX (obtained from Shimadzu Corporation)

### -Evaluation Criteria-

A: The strength of 5 N/15 mm or greater was obtained.

B: The strength of 3 N/15 mm or greater but less than 5 N/15 mm was obtained.

C: The strength of 1 N/15 mm or greater but less than 3 N/15 mm was obtained.

D: The strength of less than 1 N/15 mm was obtained.

### Color Bleeding

The pre-processing fluid was applied with a bar coater onto a PET film (E5100, obtained from TOYOBO CO., LTD.), followed by drying. An inkjet printer (IPSIO GXe5500, obtained from Ricoh Company Limited) was charged with the produced ink, and the black ink was applied onto the PET film to which the pre-processing fluid composition had been applied to print gothic-font outlined letters, followed by drying.

The readability of the obtained characters was judged with naked eyes, and was visually evaluated based on the following criteria.

In Table 5 to Table 8, the symbol “-” means that no evaluation was performed because no use of a black ink.

### -Evaluation Criteria-

A: The letters of 3 pt could be read.

B: The letters of 3 pt could not be read, but the letters of 4 pt could be read.

C: The letters of 4 pt could not be read, but the letters of 5 pt could be read.

D: The letters of 5 pt could not be read.

### <Storage Stability (Dispersion Stability)>

The produced pre-processing fluid composition was placed in a sealed container, and was left to stand for 7 days in a constant temperature bath of 70° C. The viscosity of the pre-processing fluid composition before and after the storage was measured, and storage stability (dispersion stability) of the pre-processing fluid composition was evaluated from the viscosity change rate. The viscosity was measured by means of a dynamic viscoelasticity measuring device (AR2000 Rheometer, obtained from TA Instruments) in the environment of 25° C. and 50%RH. The cone plate (diameter: 40 mm, 1 degree) was used, and the viscosity was measured at the gap of 38 micrometers, and shear velocity of 200 (⅟s).

### -Evaluation Criteria-

A: The viscosity change rate was 10% or less.

B: The viscosity change rate was greater than 10%, but 20% or less.

C: The viscosity change rate was greater than 20%, but 50% or less.

D: The viscosity change rate was greater than 50%, or there were visually recognizable aggregates generated.

TABLE 5

| | | | | | | | | |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Pre-processing fluid No. | 1 | 2 | 3 | 4 | 2 | 2 | 2 | 2 |
| Ink No. | 1 | 1 | 1 | 1 | 2 | 3 | 4 | 5 |
| Amount of pre-processing fluid applied (g/m²) | 1.5 | 1.5 | 1.5 | 1.5 | 1.5 | 1.5 | 1.5 | 1.5 |
| Laminate strength of printed area | A | A | A | B | A | A | A | A |
| Storage stability (dispersion stability) | A | A | A | A | A | A | A | A |
| Color bleeding | A | A | A | A | - | - | - | - |

TABLE 6

| | | | | | | |
|---|---|---|---|---|---|---|
| | Ex. 9 | Ex. 10 | Ex. 11 | Ex. 12 | Ex. 13 | Ex. 14 |
| Pre-processing fluid No. | 5 | 6 | 7 | 8 | 9 | 10 |
| Ink No. | 1 | 1 | 1 | 1 | 1 | 1 |
| Amount of pre-processing fluid applied (g/m²) | 1.5 | 1.5 | 1.5 | 1.5 | 1.5 | 1.5 |
| Laminate strength of printed area | B | B | A | A | A | A |
| Storage stability (dispersion stability) | A | A | A | A | A | A |
| Color bleeding | A | A | A | C | B | A |

TABLE 7

| | | | | | | | | |
|---|---|---|---|---|---|---|---|---|
| | Ex. 15 | Ex. 16 | Ex. 17 | Ex. 18 | Ex. 19 | Ex. 20 | Ex. 21 | Ex. 22 |
| Pre-processing fluid No. | 13 | 14 | 15 | 15 | 1 | 1 | 1 | 20 |
| Ink No. | 1 | 1 | 1 | 1 | 1 | 1 | 1 | 1 |
| Amount of pre-processing fluid applied (g/m²) | 1.5 | 1.5 | 1.5 | 1.5 | 0.5 | 3 | 6.5 | 1.5 |
| Laminate strength of printed area | A | A | A | A | B | A | A | B |
| Storage stability (dispersion stability) | A | A | A | A | A | A | A | A |
| Color bleeding | A | A | A | A | B | A | B | B |

TABLE 8

| | | | | | | | |
|---|---|---|---|---|---|---|---|
| | Comp. Ex. 1 | Comp. Ex. 2 | Comp. Ex. 3 | Comp. Ex. 4 | Comp. Ex. 5 | Comp. Ex. 6 | Comp. Ex. 7 |
| Pre-processing fluid No. | 16 | 17 | 18 | 19 | 12 | 21 | 11 |
| Ink No. | 1 | 1 | 1 | 1 | 1 | 1 | 1 |
| Amount of pre-processing fluid applied (g/m²) | 1.5 | 1.5 | 1.5 | 1.5 | 1.5 | 1.5 | 1.5 |
| Laminate strength of printed area | D | A | A | D | D | D | D |
| Storage stability (dispersion stability) | A | D | A | A | A | A | A |
| Color bleeding | A | A | D | A | A | A | A |

For example, aspects and embodiments of the present disclosure are as follows.

<1> A pre-processing fluid composition including:
nonionic resin particles;
a water-soluble metal salt; and
water,
wherein the nonionic resin particles comprise a nonionic resin having a structure derived from an aromatic ring-containing polyester polyol, and
the nonionic resin particles have a glass transition temperature of -30° C. or higher but 10° C. or lower.

<2> The pre-processing fluid composition according to <1>, wherein the nonionic resin particles comprise a urethane resin.

<3> The pre-processing fluid composition according to <1> or <2>, wherein a proportion of the nonionic resin particles in the pre-processing fluid composition is 5% by mass or greater but 30% by mass or less.

<4> The pre-processing fluid composition according to any one of <1> to <3>, wherein the water-soluble metal salt comprises a divalent or trivalent metal ion.

<5> The pre-processing fluid composition according to any one of <1> to <4>, wherein the nonionic resin particles comprise a resin having a structure derived from polyethylene glycol, or polypropylene glycol, or both.

<6> A printing method including:
applying the pre-processing fluid composition according to any one of <1> to <5> onto a non-permeable base; and
applying an ink by an inkjet system.

<7> The printing method according to <6>, wherein an amount of the pre-processing fluid composition applied in the applying the pre-processing fluid composition is 1 g/m² or greater but 6 g/m² or less.

<8> The printing method according to <6> or <7>,
wherein the ink includes a first ink and a second ink, and
one of the first ink and the second ink is an ink selected from a cyan ink, a magenta ink, a yellow ink, and a black ink, and the other one of the first ink and the second ink is a white ink.

<9> The printing method according to <8>, further including:
applying the first ink after the applying the pre-processing fluid composition, and
applying the second ink after the applying the first ink.

The pre-processing fluid composition according to any one of <1> to <5> and the printing method according to any one of <6> to <9> can solve the above-described various problems existing in the art, and can achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2020-198179, filed on Nov. 30, 2020 and Japanese Patent Application No. 2021-161502, filed on Sep. 30, 2021, in the Japan Patent Office, the entire disclosure of each of which is hereby incorporated by reference herein.

1. A pre-processing fluid composition, comprising:
nonionic resin particles;
a water-soluble metal salt: and
water,
wherein the nonionic resin particles comprise a nonionic resin having a structure derived from an aromatic ring-containing polyester polyol, and
the nonionic resin particles have a glass transition temperature of -30° C. or higher but 10° C. or lower.

2. The pre-processing fluid composition according to claim 1,
wherein the nonionic resin particles comprise a urethane resin.

3. The pre-processing fluid composition according to claim 1,
wherein a proportion of the nonionic resin particles in the pre-processing fluid composition is 5% by mass or greater but 30% by mass or less.

4. The pre-processing fluid composition according to claim 1,
wherein the water-soluble metal salt comprises a divalent or trivalent metal ion.

5. The pre-processing fluid composition according to claim 1,
wherein the nonionic resin particles comprise a resin having a structure derived from polyethylene glycol, or polypropylene glycol, or both.

6. A printing method, comprising:
applying the pre-processing fluid composition according to claim 1 onto a non-permeable base; and
applying an ink by an inkjet system.

7. The printing method according to claim 6,
wherein an amount of the pre-processing fluid composition applied in the applying the pre-processing fluid composition is 1 g/m² or greater but 6 g/m² or less.

8. The printing method according to claim 6,
wherein the ink includes a first ink and a second ink, and
one of the first ink and the second ink is an ink selected from a cyan ink, a magenta ink, a yellow ink, and a black ink, and the other one of the first ink and the second ink is a white ink.

9. The printing method according to claim 8, further comprising:
applying the first ink after the applying the pre-processing fluid composition, and
applying the second ink after the applying the first ink.
